(19) United States
(12) Patent Application Publication
(10) Pub. No.: US 2019/0026152 A1
(43) Pub. Date: Jan. 24, 2019

(54) INFORMATION PROCESSING APPARATUS AND INFORMATION PROCESSING SYSTEM

(71) Applicant: FUJI XEROX CO., LTD., Tokyo (JP)

(72) Inventor: Shohei MASUNAGA, Kanagawa (JP)

(73) Assignee: FUJI XEROX CO., LTD., Tokyo (JP)

(21) Appl. No.: 15/950,529

(22) Filed: Apr. 11, 2018

(30) Foreign Application Priority Data
Jul. 20, 2017 (JP) 2017-140642

(51) Int. Cl. G06F 9/50; H04L 12/14; H04L 29/08; G06F 9/455; G06Q 30/02

(52) U.S. Cl. CPC G06F 9/5011; H04L 12/1439; G06Q 30/0283; G06F 9/45533; G06F 9/5083; H04L 67/1012

(57) ABSTRACT

An information processing apparatus includes an acquisition unit that acquires an amount of operating resources among plural resources, in each of which a usage fee per unit time is defined, and an amount of jobs to be executed by using the plural resources, an identifying unit that identifies a resource whose operation is to be halted when the acquired amount of resources is more than a reference that is defined in advance relative to the acquired amount of jobs, a first instruction unit that gives an instruction to prohibit acquisition of a new job to the resource identified by the identifying unit, and a second instruction unit that gives an instruction to halt the operation of the resource identified by the identifying unit when the second instruction unit has acquired information indicating that a job under processing is not present in the resource identified by the identifying unit.

### CROSS-REFERENCE TO RELATED APPLICATIONS

This application is based on and claims priority under 35 USC 119 from Japanese Patent Application No. 2017-140642 filed Jul. 20, 2017.

### BACKGROUND

### Technical Field

The present invention relates to an information processing apparatus and an information processing system.

### Summary

According to an aspect of the invention, there is provided an information processing apparatus including an acquisition unit that acquires an amount of operating resources among plural resources, in each of which a usage fee per unit time is defined, and an amount of jobs to be executed by using the plural resources, an identifying unit that identifies a resource whose operation is to be halted when the acquired amount of resources is more than a reference that is defined in advance relative to the acquired amount of jobs, a first instruction unit that gives an instruction to prohibit acquisition of a new job to the resource identified by the identifying unit, and a second instruction unit that gives an instruction to halt the operation of the resource identified by the identifying unit when the second instruction unit has acquired information indicating that a job under processing is not present in the resource identified by the identifying unit.

### BRIEF DESCRIPTION OF THE DRAWINGS

An exemplary embodiment of the present invention will be described in detail based on the following figures, wherein:

FIG. 1 illustrates the overall configuration of one exemplary embodiment of the present invention;

FIG. 2 is a block diagram illustrating the hardware configuration of a management apparatus;

FIG. 3 is a block diagram illustrating the hardware configuration of a monitoring apparatus;

FIG. 4 is a block diagram illustrating the hardware configuration of a control apparatus;

FIG. 5 is a functional block diagram of the management apparatus, the monitoring apparatus, and the control apparatus;

FIG. 6 is a flowchart illustrating a flow of processing to be performed by the management apparatus;

FIG. 7 illustrates an example of a table stored in the management apparatus;

FIG. 8 illustrates an operation of identifying a resource to be removed;

FIG. 9 is a flowchart illustrating a flow of processing to be performed by a resource; and

FIG. 10 illustrates a modified example.

### DETAILED DESCRIPTION

### Exemplary Embodiment

### Overall Configuration

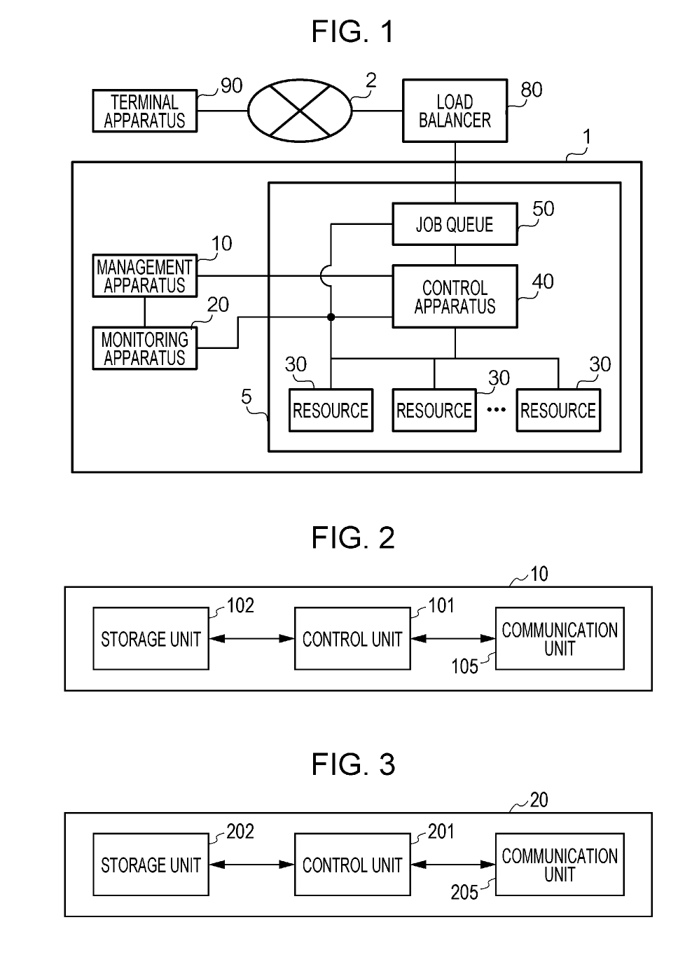

FIG. 1 illustrates the overall configuration of one exemplary embodiment of the present invention. An information processing system 1 provides resources 30 that perform information processing to a user of the information processing system 1. The resource 30 according to this exemplary embodiment is a virtual machine implemented by a physical computer. Data communications are performed via a communication network 2 and plural computers that perform data communications are connected to the communication network 2.

A terminal apparatus 90 is a computer to be used by a user who uses the resources 30 and is connected to the communication network 2. For example, the terminal apparatus 90 is a personal computer. The user operates the terminal apparatus 90 and causes the resources 30 provided by the information processing system 1 to perform information processing. FIG. 1 illustrates one terminal apparatus 90 alone in order to prevent complexity of illustration. The terminal apparatus 90 is not limited to the personal computer but may be, for example, a tablet terminal, a smartphone, or a laptop personal computer. A load balancer 80 is connected to the communication network 2 and a job queue 50. The load balancer 80 is a so-called load sharing apparatus, which acquires an information processing request transmitted from the terminal apparatus 90 and supplies the acquired request to the job queue 50. In the following description, for convenience of the description, the information processing to be performed by the resource 30 is referred to as a job and information necessary to execute the job is referred to as job information. The terminal apparatus 90 may supply the request to the job queue 50 without intervention of the load balancer 80.

The information processing system 1 includes a cloud system 5, a management apparatus 10, and a monitoring apparatus 20. The cloud system 5 provides information processing to be performed by the resources 30 to the user of the terminal apparatus 90 and includes the job queue 50, a control apparatus 40, and plural resources 30. In the exemplary embodiment of the present invention, the management apparatus 10 and the monitoring apparatus 20 may be arranged in the cloud system 5.

The job queue 50 includes a storage apparatus that stores information. The job queue 50 stores job information transmitted from the load balancer 80. The control apparatus 40 that is an example of a control apparatus according to the exemplary embodiment of the present invention provides the job information and information related to the resources 30 to the monitoring apparatus 20 and scales in or out the resources 30 in response to an instruction from the management apparatus 10.

The plural resources 30 that are examples of resources according to the exemplary embodiment of the present invention are apparatuses that process supplied job information. The resources 30 acquire the job information from the job queue 50. In this exemplary embodiment, each of the plural resources 30 is a virtual machine to be scaled in or out by the control apparatus 40. For example, the resource 30 processes an image processing job and a document translation job. The jobs to be processed by the resource 30 are not limited to those jobs but may be other jobs. In the cloud system 5, a usage fee per unit time is defined for the resource 30 in advance. In this exemplary embodiment, a fixed usage fee per fixed unit time is defined for each of the plural resources 30 and the user is charged in accordance with a usage time of the resource 30.

The monitoring apparatus 20 is connected to the control apparatus 40, the management apparatus 10, the resources 30, and the job queue 50. The monitoring apparatus 20 is a computer that accesses each resource 30 to monitor an operation status of the resource 30, an operation time of the resource 30, a load on the resource 30, a job executed by the resource 30, and the like. The monitoring apparatus 20 also accesses the job queue 50 to monitor the amount of jobs stored in the job queue 50. The monitoring apparatus 20 provides, to the management apparatus 10, information necessary to scale in and out the resources 30. The management apparatus 10 that is an example of an information processing apparatus according to the exemplary embodiment of the present invention is connected to the monitoring apparatus 20 and the control apparatus 40. The management apparatus 10 controls the number of resources 30. The management apparatus 10 scales in or out the resources 30 by using the information provided from the monitoring apparatus 20.

### Configuration of Management Apparatus 10

FIG. 2 is a block diagram illustrating an example of the hardware configuration of the management apparatus 10. A communication unit 105 is a communication interface for communications with the control apparatus 40 and the monitoring apparatus 20. A storage unit 102 includes a storage apparatus (for example, a hard disk drive) that permanently stores a program to be executed by a control unit 101 and information supplied from the monitoring apparatus 20. The control unit 101 includes a CPU and a RAM. The control unit 101 executes the program stored in the storage unit 102 and controls the storage unit 102 and the communication unit 105. The control unit 101 that is executing the program stored in the storage unit 102 acquires information provided from the monitoring apparatus 20 and performs processing of scaling in or out the resources 30.

### Configuration of Monitoring Apparatus 20

FIG. 3 is a block diagram illustrating an example of the hardware configuration of the monitoring apparatus 20. A communication unit 205 is a communication interface for communications with the job queue 50, the resources 30, the control apparatus 40, and the management apparatus 10. A storage unit 202 includes a storage apparatus (for example, a hard disk drive) that permanently stores a program to be executed by a control unit 201 and information acquired from the control apparatus 40. The control unit 201 includes a CPU and a RAM. The control unit 201 executes the program stored in the storage unit 202 and controls the storage unit 202 and the communication unit 205. The control unit 201 that is executing the program stored in the storage unit 202 acquires information transmitted from the control apparatus 40, the job queue 50, and the resources 30 and provides information to the management apparatus 10.

### Configuration of Control Apparatus 40

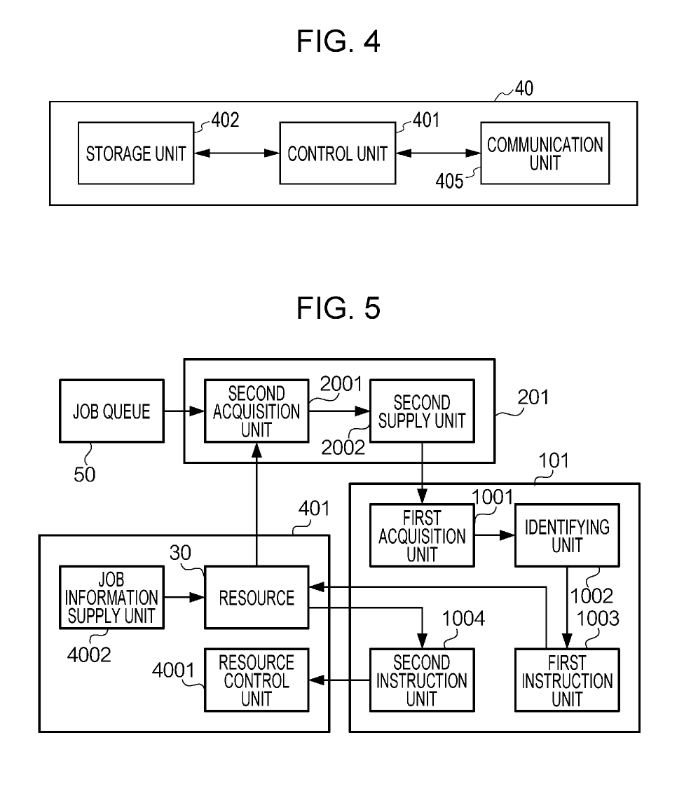

FIG. 4 is a block diagram illustrating an example of the hardware configuration of the control apparatus 40. A communication unit 405 is a communication interface for communications with the resources 30, the job queue 50, the management apparatus 10, and the monitoring apparatus 20. A storage unit 402 includes a storage apparatus (for example, a hard disk drive) that permanently stores a program to be executed by a control unit 401. The control unit 401 includes a CPU and a RAM. The control unit 401 executes the program stored in the storage unit 402 and controls the storage unit 402 and the communication unit 405. The control unit 401 that is executing the program stored in the storage unit 402 scales in or out the resources 30.

### Functional Configurations of Management Apparatus 10 and Monitoring Apparatus 20

FIG. 5 is a block diagram illustrating the configurations of functions implemented such that the control unit 101 executes the program, functions implemented such that the control unit 201 executes the program, and functions implemented such that the control unit 401 executes the program.

In the control unit 401, a resource control unit 4001 and a job information supply unit 4002 are implemented. The resource control unit 4001 scales in or out the resources 30. The job information supply unit 4002 supplies, to the resources 30, job information supplied from the job queue 50. The resources 30 supply information on the number of operating resources 30, operating periods of the resources 30, job processing statuses of the resources 30, and the like to the monitoring apparatus 20 at predetermined time intervals.

In the control unit 201, a second acquisition unit 2001 and a second supply unit 2002 are implemented. The second acquisition unit 2001 acquires information supplied from the resources. Further, the second acquisition unit 2001 acquires information indicating the amount of jobs stored in the job queue 50. The second supply unit 2002 supplies first information including the information acquired by the second acquisition unit 2001 to the management apparatus 10.

In the control unit 101, a first acquisition unit 1001, an identifying unit 1002, a first instruction unit 1003, and a second instruction unit 1004 are implemented. The first acquisition unit 1001 acquires the first information supplied from the second supply unit 2002. The identifying unit 1002 identifies a resource whose operation is to be halted when the amount of operating resources is more than a reference that is defined in advance relative to the amount of jobs included in the first information. The first instruction unit 1003 transmits, to the resource identified by the identifying unit 1002, a message indicating an instruction to prohibit acquisition of a new job. The second instruction unit 1004 transmits a message indicating an instruction to halt the operation of the resource 30 identified by the identifying unit 1002 when the second instruction unit 1004 has acquired a message indicating that a job under processing is not present in the resource 30 identified by the identifying unit 1002.

### Example of Operation of Exemplary Embodiment

Next, an example of an operation of this exemplary embodiment is described. First, when the user has performed an operation of giving an instruction to execute a job on the terminal apparatus 90, job information that is information necessary to execute the job is transmitted from the terminal apparatus 90 to the load balancer 80. The load balancer 80 supplies the job information transmitted from the terminal apparatus 90 to the job queue 50.

The monitoring apparatus 20 (second acquisition unit 2001) acquires the amount of jobs stored in the job queue 50. Further, the monitoring apparatus 20 (second acquisition unit 2001) acquires information including the number of operating resources 30, operating periods of the resources 30, and job processing statuses of the resources 30 at predetermined time intervals. The monitoring apparatus 20 (second supply unit 2002) supplies first information including the acquired information on the resources 30 and the information acquired from the job queue 50 to the management apparatus 10.

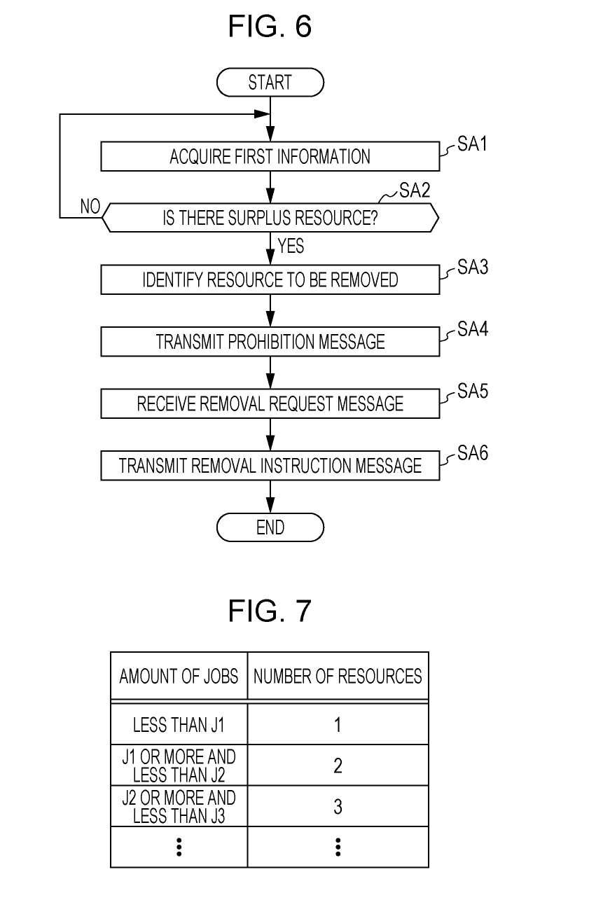

FIG. 6 is a flowchart illustrating a flow of processing to be performed by the management apparatus 10. The management apparatus 10 (first acquisition unit 1001) acquires the first information supplied from the monitoring apparatus 20 (Step SA1). Next, the management apparatus 10 (identifying unit 1002) determines whether a surplus resource 30 is present by using the acquired first information (Step SA2). Specifically, for example, the management apparatus 10 stores a table in which the amount of jobs and the number of resources are associated with each other. FIG. 7 illustrates an example of the table in which the amount of jobs and the number of resources are associated with each other. In the table, appropriate numbers of resources are associated with the amounts of jobs. The number of resources stored in the table is an example of the reference defined in advance according to the exemplary embodiment of the present invention. For example, when the amount of jobs included in the first information falls within a range of J2 or more and less than J3, the management apparatus 10 acquires “3” associated with the range of “J2 or more and less than J3” from the table as the number of resources that is appropriate to process the job of this amount. Next, the management apparatus 10 compares the number acquired from the table with the number of operating resources included in the first information. When the number of operating resources 30 included in the first information is equal to or less than the number acquired from the table, the management apparatus 10 determines that the surplus resource 30 is not present (NO in Step SA2) and returns the flow of processing to Step SA1. When the number of operating resources 30 included in the first information is more than the number acquired from the table, the management apparatus 10 determines that the surplus resource 30 is present (YES in Step SA2).

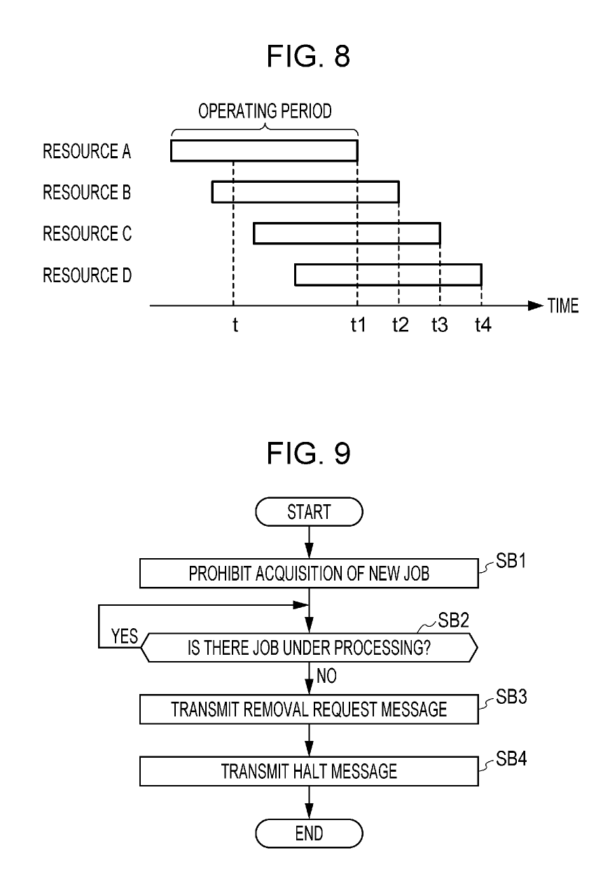

When the result of determination in Step SA2 is “YES”, the management apparatus 10 (identifying unit 1002) identifies the resource 30 to be removed (whose operation is to be halted) (Step SA3). FIG. 8 illustrates an operation of identifying the resource 30 to be removed. In FIG. 8, the horizontal axis represents time and the rectangles represent operating periods of a resource A to a resource D that are extracted from the first information. The resource A to the resource D are examples of the resource 30. In FIG. 8, “t” represents a timing when the processing of Step SA3 is performed, “t1” represents a timing when a fee is charged next on the resource A, “t2” represents a timing when a fee is charged next on the resource B, “t3” represents a timing when a fee is charged next on the resource C, and “t4” represents a timing when a fee is charged next on the resource D.

The management apparatus 10 selects, as the resource 30 to be removed, a resource 30 whose charging timing is closer to the timing when the processing of Step SA3 is performed. For example, when the number of surplus resources is 1 at the timing “t”, the resource whose charging timing is closest to the timing “t” is the resource A whose charging timing is “t1”. In this case, the management apparatus 10 identifies the resource A as the resource 30 to be removed. For example, when the number of surplus resources is 2 at the timing “t”, the resource whose charging timing is closest to the timing “t” is the resource A whose charging timing is “t1” and the resource whose charging timing is second closest to the timing “t” is the resource B whose charging timing is “t2”. In this case, the management apparatus 10 identifies the resource A and the resource B as the resources 30 to be removed.

Resources 30 whose next charging timing precedes an estimated completion time of a job under processing may be excluded from the resources to be removed and other resources 30 may be selected.

When the resource 30 to be removed is selected, the management apparatus 10 (first instruction unit 1003) transmits, to the selected resource 30, a prohibition message indicating an instruction to prohibit acquisition of a job (Step SA4). The prohibition message transmitted from the management apparatus 10 is acquired by the resource 30 that is selected by the management apparatus 10 in Step SA3.

FIG. 9 is a flowchart illustrating a flow of processing to be performed by the resource 30 that has acquired the prohibition message. The resource 30 that has acquired the prohibition message first prohibits acquisition of a new job from the job queue 50 (Step SB1). Next, the resource 30 determines whether a job under processing is present (Step SB2). When a job under processing is present (YES in Step SB2), the resource 30 waits until the job under processing is finished. When a job under processing is not present (NO in Step SB2), the resource 30 transmits, to the management apparatus 10, a removal request message indicating a request to remove the resource 30 (Step SB3). The removal request message is an example of the message indicating that a job under processing is not present in the resource 30.

The management apparatus 10 (second instruction unit 1004) receives the removal request message transmitted from the resource 30 (Step SA5). When the removal request message is received, the management apparatus 10 transmits a removal instruction message indicating an instruction to remove the resource 30 identified in Step SA3 (Step SA6). The removal instruction message is an example of the message indicating an instruction to halt the operation of the resource 30. The removal instruction message transmitted from the management apparatus 10 is acquired by the control apparatus 40. The control apparatus 40 removes the resource 30 specified in the removal instruction message.

The prohibition message to be transmitted from the management apparatus 10 may include information indicating the resource 30 that is prohibited from acquiring a job. This prohibition message may be acquired by the control apparatus 40 and the control apparatus 40 may prohibit supply of a job to the resource 30 indicated by the information included in the prohibition message. Further, the control apparatus 40 may monitor the resources 30 and, when a job under processing is not present in the resource 30 in which the supply of a job is prohibited, the control apparatus 40 may transmit, to the management apparatus 10, a removal request message indicating a request to remove the resource 30 in which the supply of a job is prohibited. The management apparatus 10 may instruct the control apparatus 40 to remove the resource 30 that is requested for removal in the removal request message and the instructed control apparatus 40 may remove the resource 30.

According to this exemplary embodiment, the resource 30 having a job under processing is not removed while processing the job. According to this exemplary embodiment, when surplus resources 30 are present compared with the amount of jobs to be processed, a resource 30 that has finished processing the job is removed and the number of resources 30 is reduced.

### Modified Examples

The exemplary embodiment of the present invention is described above but is not limitative and various other exemplary embodiments may be employed. For example, the exemplary embodiment described above may be modified as follows. The exemplary embodiment described above and the following modified examples may be combined with each other.

In the exemplary embodiment described above, the resource 30 is a virtual machine. For example, the resource 30 may be a server or storage that is a physical computer. When the resource 30 is a physical computer, an operation of the computer is halted instead of removing a virtual machine.

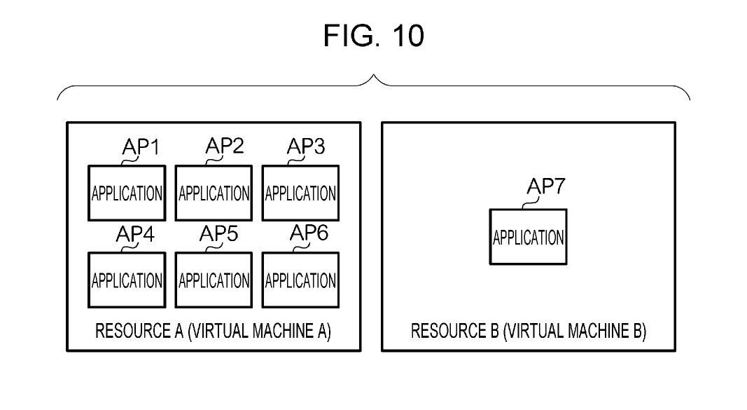

In the exemplary embodiment of the present invention, the resource 30 may be an application that operates on a virtual machine. This modified example is described in detail with reference to FIG. 10. FIG. 10 illustrates a state in which six applications AP1 to AP6 operate on a resource A that is a virtual machine and one application AP7 operates on a resource B that is a virtual machine. The applications AP1 to AP7 are examples of the resource 30. The management apparatus 10 acquires first information including the amount of jobs stored in the job queue 50, the number of applications operating on the resource A, and the number of applications operating on the resource B. The management apparatus 10 acquires, from a table, the number of resources that is appropriate to process the amount of jobs included in the first information and determines whether a surplus application is present by comparing the number acquired from the table with the number of operating applications. When a surplus application is present, the management apparatus 10 identifies a virtual machine having a smaller number of operating applications among the plural virtual machines and selects the applications operating on the identified virtual machine as resources 30 to be removed. In the case of the example illustrated in FIG. 10, the resource B has a smaller number of operating applications and therefore the management apparatus 10 selects the application AP7 as the resource 30 to be removed.

When the resource 30 to be removed is selected, the management apparatus 10 transmits, to the selected resource 30, a prohibition message indicating an instruction to prohibit acquisition of a job. When the prohibition message is acquired, the application AP7 prohibits acquisition of a new job and determines whether a job under processing is present. When a job under processing is not present, the application AP7 transmits a removal request message to the management apparatus 10. The management apparatus 10 receives the removal request message transmitted from the application AP7. When the removal request message is received, the management apparatus 10 transmits a removal instruction message indicating an instruction to remove the application AP7 to be removed. The removal instruction message transmitted from the management apparatus 10 is acquired by the resource B. The resource B removes the application AP7 specified in the removal instruction message.

When the application AP7 on the resource B is removed, the resource B has no operating application. When a virtual machine having no operating application is present, the management apparatus 10 transmits a removal instruction message indicating an instruction to remove the virtual machine. The removal instruction message transmitted from the management apparatus 10 is acquired by the control apparatus 40. The control apparatus 40 removes the resource B specified in the removal instruction message.

In the exemplary embodiment described above, the management apparatus 10 may analyze the acquired first information and, when a resource 30 having no job under processing is present among the plural resources 30, the management apparatus 10 may transmit a removal instruction message indicating an instruction to remove the resource 30.

In the exemplary embodiment described above, the monitoring apparatus 20 supplies the first information to the management apparatus 10. The management apparatus 10 may have the function of the monitoring apparatus 20 and acquire the first information without intervention of the monitoring apparatus 20.

In the exemplary embodiment described above, when the removal request message is not received within a predetermined time after the prohibition message has been transmitted in Step SA4, the management apparatus 10 may transmit the removal instruction message even though the removal request message is not received.

In the exemplary embodiment described above, the management apparatus 10 may acquire, from the table, the number of resources associated with the amount of jobs included in the first information after the prohibition message has been transmitted and, when the number of operating resources 30 included in the first information is less than the number acquired from the table, the management apparatus 10 may transmit a message indicating an instruction to acquire a job to the resource 30 that has acquired the prohibition message. This message is acquired by the resource 30 that has acquired the prohibition message. The resource 30 that has acquired the message resumes acquiring a job and processes the acquired job.

In the exemplary embodiment described above, the control apparatus 40 scales in and out the resources 30 but the management apparatus 10 may scale in and out the resources 30.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus, comprising:
an acquisition unit that acquires an amount of operating resources among a plurality of resources, in each of which a usage fee per unit time is defined, and an amount of jobs to be executed by using the plurality of resources;
an identifying unit that identifies a resource whose operation is to be halted when the acquired amount of resources is more than a reference that is defined in advance relative to the acquired amount of jobs;
a first instruction unit that gives an instruction to prohibit acquisition of a new job to the resource identified by the identifying unit; and
a second instruction unit that gives an instruction to halt the operation of the resource identified by the identifying unit when the second instruction unit has acquired information indicating that a job under processing is not present in the resource identified by the identifying unit.

2. The information processing apparatus according to claim 1, wherein the resource identified by the identifying unit is a resource in which a period from a timing of identification to a timing to charge the usage fee is shortest.

3. The information processing apparatus according to claim 2, wherein, when a plurality of resources are identified, the identifying unit sequentially identifies the resources in ascending order of the period from the timing of identification to the timing to charge the usage fee.

4. The information processing apparatus according to claim 1, wherein the second instruction unit gives the instruction to halt the operation of the resource identified by the identifying unit when the second instruction unit has acquired information indicating the instruction to halt the operation from the resource identified by the identifying unit as the information indicating that the job under processing is not present.

5. The information processing apparatus according to claim 2, wherein the second instruction unit gives the instruction to halt the operation of the resource identified by the identifying unit when the second instruction unit has acquired information indicating the instruction to halt the operation from the resource identified by the identifying unit as the information indicating that the job under processing is not present.

6. The information processing apparatus according to claim 3, wherein the second instruction unit gives the instruction to halt the operation of the resource identified by the identifying unit when the second instruction unit has acquired information indicating the instruction to halt the operation from the resource identified by the identifying unit as the information indicating that the job under processing is not present.

7. The information processing apparatus according to claim 4, wherein the resource supplies the information indicating the instruction to halt the operation to the second instruction unit when the resource has finished processing the job under processing after acquiring the instruction from the first instruction unit.

8. The information processing apparatus according to claim 5, wherein the resource supplies the information indicating the instruction to halt the operation to the second instruction unit when the resource has finished processing the job under processing after acquiring the instruction from the first instruction unit.

9. The information processing apparatus according to claim 6, wherein the resource supplies the information indicating the instruction to halt the operation to the second instruction unit when the resource has finished processing the job under processing after acquiring the instruction from the first instruction unit.

10. The information processing apparatus according to claim 1, wherein the resource identified by the identifying unit is instructed to acquire a job when the acquired amount of resources is less than the reference that is defined in advance relative to the acquired amount of jobs at a timing succeeding a timing when the first instruction unit has given the instruction.

11. The information processing apparatus according to claim 2, wherein the resource identified by the identifying unit is instructed to acquire a job when the acquired amount of resources is less than the reference that is defined in advance relative to the acquired amount of jobs at a timing succeeding a timing when the first instruction unit has given the instruction.

12. The information processing apparatus according to claim 3, wherein the resource identified by the identifying unit is instructed to acquire a job when the acquired amount of resources is less than the reference that is defined in advance relative to the acquired amount of jobs at a timing succeeding a timing when the first instruction unit has given the instruction.

13. The information processing apparatus according to claim 4, wherein the resource identified by the identifying unit is instructed to acquire a job when the acquired amount of resources is less than the reference that is defined in advance relative to the acquired amount of jobs at a timing succeeding a timing when the first instruction unit has given the instruction.

14. The information processing apparatus according to claim 5, wherein the resource identified by the identifying unit is instructed to acquire a job when the acquired amount of resources is less than the reference that is defined in advance relative to the acquired amount of jobs at a timing succeeding a timing when the first instruction unit has given the instruction.

15. The information processing apparatus according to claim 6, wherein the resource identified by the identifying unit is instructed to acquire a job when the acquired amount of resources is less than the reference that is defined in advance relative to the acquired amount of jobs at a timing succeeding a timing when the first instruction unit has given the instruction.

16. The information processing apparatus according to claim 7, wherein the resource identified by the identifying unit is instructed to acquire a job when the acquired amount of resources is less than the reference that is defined in advance relative to the acquired amount of jobs at a timing succeeding a timing when the first instruction unit has given the instruction.

17. The information processing apparatus according to claim 8, wherein the resource identified by the identifying unit is instructed to acquire a job when the acquired amount of resources is less than the reference that is defined in advance relative to the acquired amount of jobs at a timing succeeding a timing when the first instruction unit has given the instruction.

18. The information processing apparatus according to claim 9, wherein the resource identified by the identifying unit is instructed to acquire a job when the acquired amount of resources is less than the reference that is defined in advance relative to the acquired amount of jobs at a timing succeeding a timing when the first instruction unit has given the instruction.

19. An information processing system, comprising:
an information processing apparatus comprising:
an acquisition unit that acquires an amount of operating resources among a plurality of resources, in each of which a usage fee per unit time is defined, and an amount of jobs to be executed by using the plurality of resources;
an identifying unit that identifies a resource whose operation is to be halted when the acquired amount of resources is more than a reference that is defined in advance relative to the acquired amount of jobs;
a first instruction unit that gives an instruction to prohibit acquisition of a new job to the resource identified by the identifying unit; and
a second instruction unit that gives an instruction to halt the operation of the resource identified by the identifying unit when the second instruction unit has acquired information indicating that a job under processing is not present in the resource identified by the identifying unit,
wherein the resource prohibits acquisition of a job in response to the instruction from the first instruction unit and supplies, when the job under processing is not present, the information indicating that the job under processing is not present to the information processing apparatus; and
a control apparatus that halts the operation of the resource identified by the identifying unit in response to the instruction from the second instruction unit.

20. An information processing apparatus, comprising:
acquisition means for acquiring an amount of operating resources among a plurality of resources, in each of which a usage fee per unit time is defined, and an amount of jobs to be executed by using the plurality of resources;
identifying means for identifying a resource whose operation is to be halted when the acquired amount of resources is more than a reference that is defined in advance relative to the acquired amount of jobs;
first instruction means for giving an instruction to prohibit acquisition of a new job to the resource identified by the identifying means; and
second instruction means for giving an instruction to halt the operation of the resource identified by the identifying means when the second instruction means has acquired information indicating that a job under processing is not present in the resource identified by the identifying means.
